(19) United States
(12) Patent Application Publication
(10) Pub. No.: US 2015/0163096 A1
(43) Pub. Date: Jun. 11, 2015

(54) SYSTEM AND METHOD FOR CONFIGURING DEVICE SOCIALITY

(71) Applicant: Intellectual Discovery Co., Ltd., Seoul (KR)

(72) Inventors: Han Ku Lee, Seoul (KR); Hyo Gun Yoon, Daejeon (KR); Myoung Jin Kim, Yongin-si (KR); Yun Cui, Seoul (KR)

(73) Assignee: INTELLECTUAL DISCOVERY CO., LTD., Seoul (KR)

(21) Appl. No.: 14/411,727

(22) PCT Filed: Jul. 1, 2013
(86) PCT No.: PCT/KR2013/005807

§ 371 Date: Dec. 29, 2014

(30) Foreign Application Priority Data
Jun. 29, 2012 (KR) 10-2012-0070466

(51) Int. Cl. H04L 12/24; H04L 29/08

(52) U.S. Cl. CPC H04L 41/0816; H04L 67/10

(57) ABSTRACT

Provided are a system and a method for configuring device sociality which constructs one or more networks through wired/wireless internet and configures device sociality for one or more devices included in one or more networks.

### TECHNICAL FIELD

The present invention relates to a system and a method for configuring device sociality in a cloud computing environment.

### BACKGROUND ART

Cloud computing may refer to next-generation computing service technology for which concepts such as software as a service (SaaS), for example, as a web 2.0 service, and utility computing are combined.

A cloud computing service may include infrastructure as a service (IaaS) providing a server, a storage, and software infrastructures to use an information technology (IT) environment, platform as a service (PaaS) to provide a platform on which software is developed, and software as a service (SaaS) providing and applying software such as enterprise resource planning (ERP) and customer relationship management (CRM) through the Internet for a computing enterprise.

The could computing service may virtualize a personal smart device to ensure connectivity of a personalized service device including a smart device connected through a network, and safety for personalized service contents.

The cloud computing may use a mobile cloud service to monitor a state of use of a connected service device in a cloud system.

The cloud computing may include a service application to use a mobile browser in Android and Mac operating system (OS) environments for a convenient service structure for a user, and a light-weight client network module to connect heterogeneous network environments to the OS environments.

The cloud computing may include background processing, low-level networking, file system access, and binary data processing to be performed on a service request and a service task in a structure through which accesses to a server system in a mobile network may be processed in parallel.

### DISCLOSURE OF INVENTION

### Technical Goals

An aspect of the present invention provides a service of configuring sociality among smart devices by analyzing states of users connected through a social network for the users of the smart devices.

Another aspect of the present invention provides a system and a method for integrating autonomous smart devices by analyzing sociality formed based on a relationship among users.

Still another aspect of the present invention provides a method of configuring device sociality that provides service contents, virtualizing devices through the configured device sociality, and processing a service.

### Technical Solutions

According to an aspect of the present invention, there is provided a system for configuring device sociality, the system including a service area configured to construct at least one network through wired and wireless Internet, and a cloud system configured to configure device sociality for at least one device in the service area.

The service area may include a naming unit configured to set a name of each device by classifying the at least one device, a protocol recognition unit configured to perform synchronization with a cloud service when the device sociality is configured for the at least one device, a service interface unit configured to manage information on a device of a user and information on a device of the cloud system, and a service control unit configured to perform remote control on the at least one device and a service.

The cloud system may include a device recognition unit configured to recognize a device to be included in sociality among the at least one device, a device sociality unit configured to configure device sociality providing a personalized service using a scenario and model information, a device virtualization unit configured to provide at least one service to the device included in the sociality, a service consecutive processing unit configured to change a device required for a service based on a spatial movement of the user and a change in a service device, and a social analysis unit configured to recommend the personalized service associated with sociality of the user and the device included in the sociality.

The device recognition unit may include a user authentication unit configured to connect at least one user, the at least one provided service, and the device included in the sociality to allow the cloud service and a device sociality service to interwork, a device recognition unit configured to verify a state of the device recognized through the cloud system, a protocol generation unit configured to synchronize the recognized device and a device of the user with the at least one provided service, and a device meta-extraction unit configured to recommend meta-information on a new device when the at least one provided service is suspended.

The device sociality unit may include a sociality configuration unit configured to configure connectivity of the recognized device to maintain a level of the at least one service and the device sociality, a sociality optimization unit configured to manage a quality of service (QoS) based on a communication environment of the model information, a device meta-management unit configured to generate an ontology structured data storage rule and manage device meta-information, a ranking processing unit configured to determine a ranking of a device required for a service by evaluating the device meta-information, service information, and service environment information, and connect and reset the at least one device by referring to the ranking, and a protocol generation unit configured to manage the resetting of the at least one device and service connectivity.

The device virtualization unit may include a virtualization management unit configured to manage cloud virtualization and device virtualization, and virtualize a resource corresponding to each device, a resource distribution unit configured to distribute a resource and information of the cloud system required for the service to be provided, a service resource conversion unit configured to unify service codes of a device receiving the service and the resource, and a service configuration unit configured to configure device sociality in a virtualized form to be provided to the user using the unified service code and the configured device sociality.

The service consecutive processing unit may include a service log analysis unit configured to analyze a state of use of the provided service and a log of the service device, a device recommendation unit configured to recommend a device adjacent to the user and without interworking with another service and being on standby, a device interface unit configured to manage an event and a message directly controlling the service device, and a service interface unit configured to allow the service to be provided to be selected or reconfigured.

The social analysis unit may include a log information collection unit configured to collect log information used for the service to be provided and log information associated with a state of the service to be provided, a social setting unit configured to set a relationship between a situation of a user included in sociality and the device included in the sociality based on the collected log information, a device matching unit configured to set a device matching relationship based on a connection state of each device, an agent management unit configured to manage the personalized service, the sociality of the user, and the device included in the sociality, and an agent protocol management unit configured to evaluate the service to be provided by comparing social network information to user information of the cloud system.

According to another aspect of the present invention, there is provided a system for configuring device sociality, the system including a resource distribution unit configured to monitor cloud service resources in real time and distribute the cloud service resources, a sociality configuration unit configured to recognize a device and configure sociality of a user and device sociality, a protocol generation unit configured to configure a sociality service, a sociality optimization unit configured to optimize the device sociality, a device virtualization unit configured to manage connection between the sociality service and the device by continuously monitoring a state of a service, a resolution conversion unit configured to automatically output the state of the service based on a resolution module of the sociality device, a device management unit configured to control the device, a device interface unit configured to manage the device, and a service interface unit configured to provide the sociality service.

According to still another aspect of the present invention, there is provided a method of configuring device sociality, the method including constructing at least one network through wired and wireless Internet, and configuring device sociality for at least one device included in the at least one network.

### Effects of Invention

According to example embodiments of the present invention, there is provided a service of configuring sociality among smart devices by analyzing states of users connected through a social network for the users of the smart devices.

According to example embodiments of the present invention, there is provided a system and a method for integrating autonomous smart devices by analyzing sociality formed based on a relationship among users.

According to example embodiment of the present invention, there is provided a method of configuring device sociality that provides service contents, virtualizing devices through the configured device sociality, and processing a service.

### BRIEF DESCRIPTION OF DRAWINGS

FIG. 1 is a diagram illustrating an example of a configuration of a system for configuring device sociality according to an embodiment of the present invention.

FIG. 2 is a diagram illustrating an example of a configuration of a cloud system according to an embodiment of the present invention.

FIG. 3 is a diagram illustrating an example of a service area and an example of a partial configuration of a cloud system according to an embodiment of the present invention.

FIG. 4 is a diagram illustrating an example of a configuration of a device sociality unit and a device virtualization unit of a cloud system according to an embodiment of the present invention.

FIG. 5 is a diagram illustrating an example of a configuration of a device virtualization unit and a service consecutive processing unit of a cloud system according to an embodiment of the present invention.

FIG. 6 is a diagram illustrating an example of a configuration of a service consecutive processing unit and a social analysis unit of a cloud system according to an embodiment of the present invention.

FIG. 7 is a diagram illustrating an example of a configuration of a social analysis unit of a cloud system according to an embodiment of the present invention.

FIG. 8 is a diagram illustrating another example of a configuration of a cloud system according to an embodiment of the present invention.

FIG. 9 is a flowchart illustrating an example of a method of configuring device sociality in a service area according to an embodiment of the present invention.

FIG. 10 is a flowchart illustrating an example of a method of configuring device sociality in a cloud system according to an embodiment of the present invention.

### BEST MODE FOR CARRYING OUT INVENTION

Reference will now be made in detail to example embodiments of the present invention, examples of which are illustrated in the accompanying drawings, wherein like reference numerals refer to the like elements throughout. Example embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the example embodiments of the present invention and thus may be changed depending on a user, the intent of an operator, or a custom. Accordingly, the terms must be defined based on the following overall description of this specification.

According to an embodiment of the present invention, a system for configuring device sociality, hereinafter also referred to as a “device sociality configuring system,” may configure the device sociality for devices allocated for each user by analyzing sociality of users and sociality of service environments to establish various service environments of cloud computing, and may provide a device suitable for service contents for a user.

According to an embodiment of the present invention, the device sociality configuring system may appropriately operate various smart devices, and provide a model that defines a relationship to provide, in real time, resources required for a cloud service.

According to an embodiment of the present invention, the device sociality configuring system may locate a smart device suitable for a cloud computing environment and provide, to a user, a suitable environment for using service contents by configuring sociality of the smart device.

According to an embodiment of the present invention, the device sociality configuring system may be applicable to an integral virtualization system for personalized cloud devices to ensure a diversity of home service contents implemented in a smart environment.

According to an embodiment of the present invention, the device sociality configuring system may integrate autonomously operating smart device environments into one in a cloud system.

According to an embodiment of the present invention, the device sociality configuring system may allow a smart device of a user to access service contents suitable for the smart device at anytime and anywhere through rapid mobility and distributed processing by recording required content resources in the cloud system.

According to an embodiment of the present invention, the device sociality configuring system may provide a smart service environment to allow groups configured through a social network of users to process information therebetween in real time.

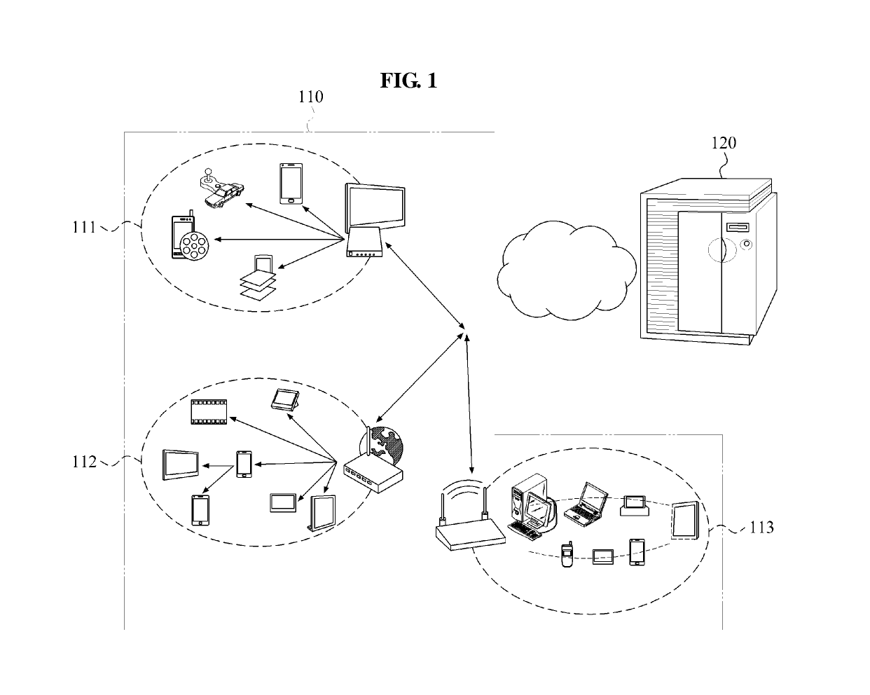

FIG. 1 is a diagram illustrating an example of a configuration of a device sociality configuring system according to an embodiment of the present invention.

According to an embodiment of the present invention, the device sociality configuring system may analyze a social network of users of smart devices using cloud computing, and provide an optimal service environment by configuring a cloud service as smart device sociality.

Referring to FIG. 1, the device sociality configuring system includes a service area 110 that constructs at least one network through wired and wireless Internet, and a cloud system 120 that configures device sociality for at least one device in the service area 110.

The service area 110 may use a service, and include all service areas enabling use of the wired and wireless Internet, for example, a home network 111, a mobile network 112, and a smart network 113.

The cloud system 120 may configure the device sociality for smart devices in an identical or a similar form based on the social network of the users.

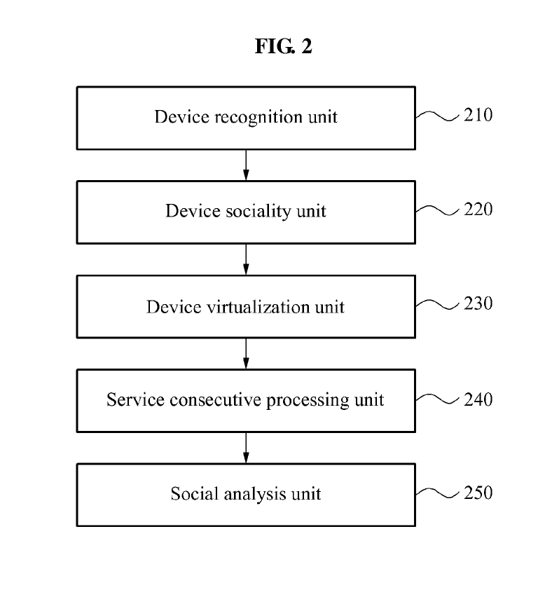

FIG. 2 is a diagram illustrating an example of a configuration of a cloud system according to an embodiment of the present invention.

Referring to FIG. 2, the cloud system includes a device recognition unit 210, a device sociality unit 220, a device virtualization unit 230, a service consecutive processing unit 240, and a social analysis unit 250.

The cloud system may recognize a device to be included in sociality among at least one device using the device recognition unit 210.

For example, the device recognition unit 210 may recognize a smart device and a mobile device to be included in the sociality from the cloud system and a personal smart device of an individual.

The device sociality unit 220 may configure device sociality that provides a personalized service using a scenario and model information.

For example, the device sociality unit 220 may store the scenario and the model information to configure the device sociality that provides a personalized device service in the cloud system.

The device virtualization unit 230 may provide at least one service to the device included in the sociality.

The cloud system may change a device required for the service based on a spatial movement of a user and a change in a service device using the service consecutive processing unit 240.

For example, the service consecutive processing unit 240 may automatically provide the change in the device required for the service based on the spatial movement of the user and the change in the service device.

The cloud system may recommend the personalized service associated with sociality of the user and the device included in the sociality using the social analysis unit 250.

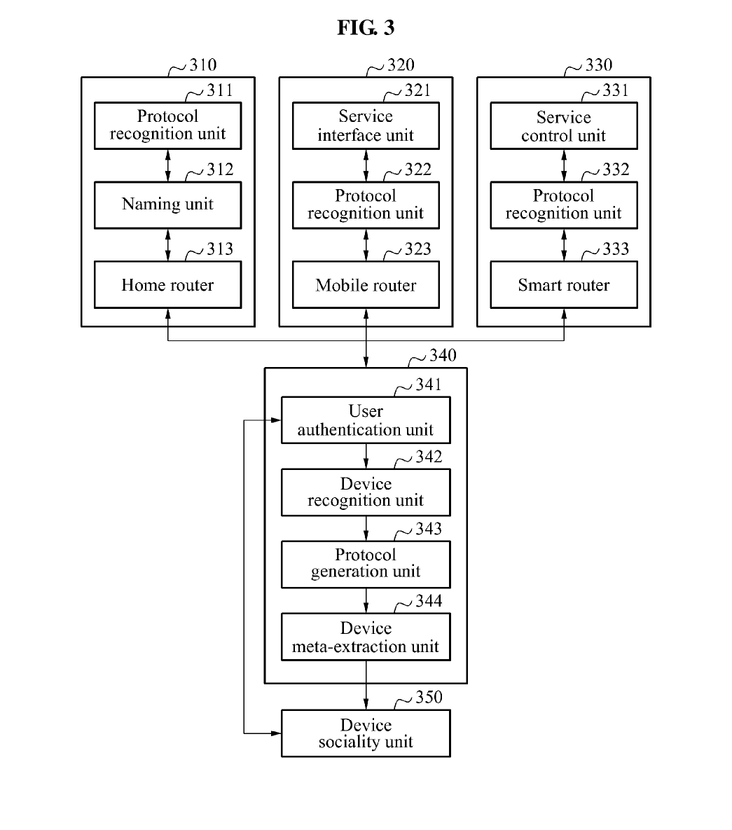

FIG. 3 is a diagram illustrating an example of a service area and an example of a partial configuration of a cloud system according to an embodiment of the present invention.

Referring to FIG. 3, the service area includes all service areas enabling use of wired and wireless Internet, for example, a home network 310, a mobile network 320, and a smart network 330.

The home network 310 may be a personal space of a user and include various service devices.

The home network 310 may classify at least one device and set a name for each device using a naming unit 312.

For example, the naming unit 312 may distinguish each device in a service environment having autonomous smart devices, such as an environment of the home network 310.

The home network 310 may use a standard communication structure, for example, digital living network alliance (DLNA) and universal plug and play (UPnP), to connect various devices through a home router 313.

The home network 310 may manage the set name of each device through the naming unit 312 to identify a recognized device.

When device sociality is configured for the at least one device, the home network 310 may perform synchronization with a cloud service using a protocol recognition unit 311.

The home network 310 may connect a sociality service of a smart device in the cloud system through the protocol recognition unit 311.

The mobile network 320 may manage information on a device of the user and information on a device of the cloud system using a service interface unit 321.

The mobile network 320 may provide device sociality to be obtained through a mobile phone or a smartphone of the user.

The mobile network 320 may connect communication with the user through a mobile router 323 provided by a communication common carrier.

The mobile network 320 may prearrange, through a protocol recognition unit 322, service preparation of a device of the user and an adjacent connectable smart device to secure connectivity of the smart device.

The mobile network 320 may perform a personalized service through the service interface 321.

The smart network 330 may perform remote control on the at least one device and a service using a service control unit 331.

The smart network 330 may provide a service linking a ubiquitous network with a personal smart space of the user or a smart space of another user.

The smart network 330 may recognize an adjacent smart device including the user of the service through a smart router 333.

The smart network 330 may synchronize the recognized smart device with the personal smart device using the service through a protocol recognition unit 332.

The smart network 330 may control a service implemented in a smart device through a service control unit 331.

As illustrated in FIG. 3, a device recognition unit 340 of the cloud system includes a user authentication unit 341, a device recognition unit 342, a protocol generation unit 343, and a device meta-extraction unit 344.

The user authentication unit 341 may connect at least one user, at least one service to be provided, and a device included in sociality to allow a cloud service and a sociality service to interwork.

For example, the user authentication unit 341 may authenticate a connected service in a smart device of a user.

The user authentication unit 341 may verify a user key, a service key, and a smart key using a Rivest, Shamir, and Adleman (RSA) algorithm through a security module connected by a cloud web service engine.

The user authentication unit 341 may perform the authentication by comparing key values recorded in a database of the user.

The device recognition unit 342 may verify a state of a device recognized through the cloud system.

For example, the device recognition unit 342 may verify a state of a device of the authenticated user for stable operation of the device.

The protocol generation unit 343 may synchronize the recognized device and the device of the user with the at least one service to be provided.

For example, the protocol generation unit 343 may perform three-tiered synchronization with a service implemented in the cloud computing to synchronize the recognized device and the device of the user.

When the at least one provided service is suspended, the device meta-extraction unit 344 may recommend meta-information on a new device.

For example, when the service is suspended, the device meta-extraction unit 344 may recommend meta-information on an adjacent smart device to recommend a new smart device.

The cloud system may achieve device optimization by transmitting collected information on a smart device, service information, and user information to a device sociality unit 350.

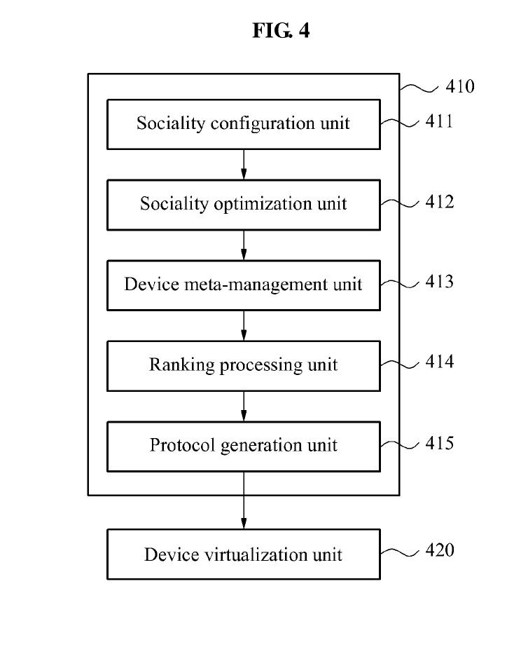

FIG. 4 is a diagram illustrating an example of a configuration of a device sociality unit 410 and a device virtualization unit 420 of a cloud system according to an embodiment of the present invention.

Referring to FIG. 4, the device sociality unit 410 includes a sociality configuration unit 411, a sociality optimization unit 412, a device meta-management unit 413, a ranking processing unit 414, and a protocol generation unit 415.

The device sociality unit 410 may configure a device sociality model for optimal synchronization of a smart device and a service.

The sociality configuration unit 411 may configure connectivity of a recognized device to maintain a level of at least one service and device sociality.

For example, the sociality configuration unit 411 may configure the connectivity of the recognized service device to maintain the level of the service implemented in each service area and the device sociality.

The sociality optimization unit 412 may manage a quality of service (QoS) based on a communication environment of model information.

For example, the sociality optimization unit 412 may improve the QoS, which is a quality level of the service, based on the communication environment of the configured model.

The device meta-management unit 413 may generate an ontology structured data storage rule, and manage device meta-information.

For example, the device meta-management unit 413 may manage collected metadata on a smart device, and generate the ontology structured data storage rule to regularize various sets of device metadata in a predetermined form.

The ranking processing unit 414 may determine a ranking of a device required for the service by evaluating the device meta-information, service information, and service environment information.

The ranking processing unit 414 may connect and reset the at least one device by referring to the ranking.

For example, when a similar service state occurs, the ranking processing unit 414 may preferentially connect a smart device corresponding to the service state, and reset the smart device through the sociality optimization unit 412.

The protocol generation unit 415 may manage the resetting of the at least one device and service connectivity.

For example, the protocol generation unit 415 may reinforce the service connectivity to reset a smart device.

The configured device sociality model may be transmitted to the device virtualization unit 420. Thus, resource virtualization, service virtualization, platform virtualization, and software virtualization for a personalized service may be performed in the cloud system.

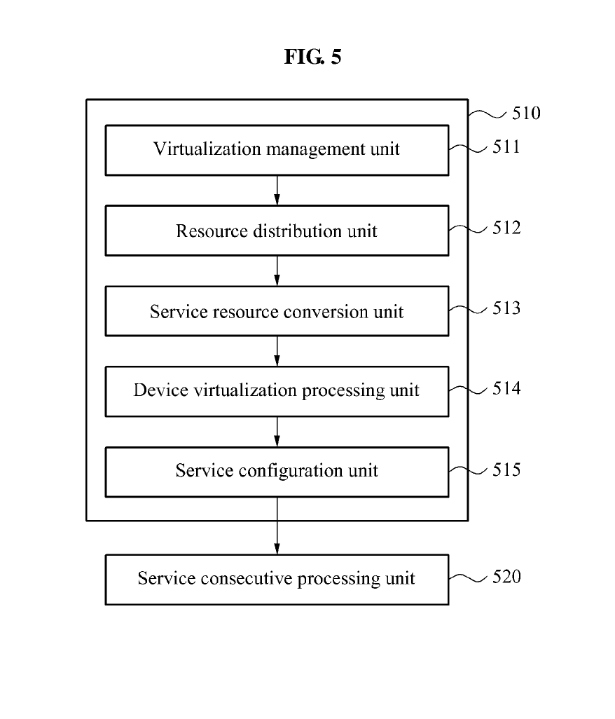

FIG. 5 is a diagram illustrating an example of a configuration of a device virtualization unit 510 and a service consecutive processing unit 520 of a cloud system according to an embodiment of the present invention.

Referring to FIG. 5, the device virtualization unit 510 includes a virtualization management unit 511, a resource distribution unit 512, a service resource conversion unit 513, and a service configuration unit 515.

The virtualization management unit 511 may manage cloud virtualization and device virtualization, and virtualize a resource corresponding to each device.

For example, the virtualization management unit 511 may allocate resources of the cloud system based on a service and a device requested by a user.

The virtualization management unit 511 may reinforce connection between a personal smart device of an individual and a smart device by performing smart device virtualization.

The resource distribution unit 512 may distribute the resources and information of the cloud system, which are required for a service to be provided.

For example, the resource distribution unit 512 may perform a function of distributing the resources and the information of the cloud system, which are required for the service to be provided, through the virtualization management unit 511.

The service resource conversion unit 513 may unify service codes of a device receiving the service and the resources.

The service configuration unit 515 may configure device sociality in a virtualized form to be provided to the user using the unified service code and the configured device sociality.

The service consecutive processing unit 520 may continuously provide a cloud computing service to the user.

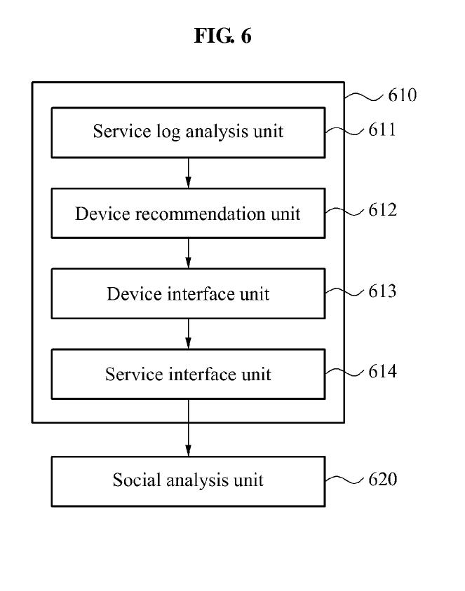

FIG. 6 is a diagram illustrating an example of a configuration of a service consecutive processing unit 610 and a social analysis unit 620 of a cloud system according to an embodiment of the present invention.

Referring to FIG. 6, the service consecutive processing unit 610 includes a service log analysis unit 611, a device recommendation unit 612, a device interface unit 613, and a service interface unit 614.

The service consecutive processing unit 610 may newly recommend a device connected through a network, for example, an adjacent smart device located around a user, and record and manage a service operation.

The service log analysis unit 611 may analyze a state of use of a provided service and a log, or log information, of a service device.

The service log analysis unit 611 may continuously manage the state of use of the service by the user and the log of a smart device being used.

The service log analysis unit 611 may analyze the smart device continuously being used and the device newly selected for the recommendation based on the log.

The service log analysis unit 611 may re-define a relationship between the device and the service based on a result of the analyzing to update the state of the service, and actively respond to a new service.

The device recommendation unit 612 may recommend a device adjacent to the user without interworking with another service or being on standby, for example, without planning to provide another service and planning to provide a service to another user.

The device interface unit 613 may manage an event and a message that directly control the service device.

The service interface unit 614 may allow the service to be provided to be selected or reconfigured.

The service interface unit 614 may allow a personalized service to be reconfigured or controlled while allowing the user to select a service.

Collected social device information and service information may be transmitted to the social analysis unit 620 to analyze a social relationship between the social device information and the service information.

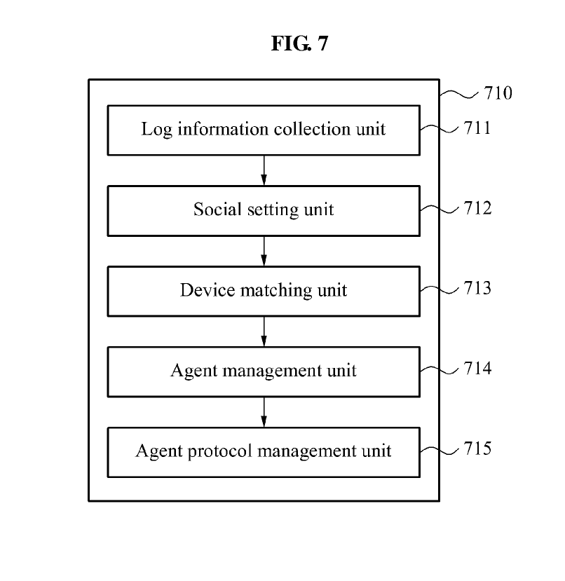

FIG. 7 is a diagram illustrating an example of a configuration of a social analysis unit 710 of a cloud system according to an embodiment of the present invention.

Referring to FIG. 7, the social analysis unit 710 includes a log information collection unit 711, a social setting unit 712, a device matching unit 713, an agent management unit 714, and an agent protocol management unit 715.

The social analysis unit 710 may analyze respective service states of an existing user and a new user in configuration of smart device sociality.

The social analysis unit 710 may re-define a relationship between a service use pattern of a user and service device information.

The log information collection unit 711 may collect log information used for a provided service and log information associated with a state of the provided service.

The log information collection unit 711 may collect all sets of the log information used for the service including meta-information on a smart device, and collect meta-information required for adjacent service state information.

The social setting unit 712 may set a relationship between a situation of the user included in sociality and a device included in sociality based on the collected log information.

The social setting unit 712 may set the relationship between a situation of a user included in an adjacent social network and a social device based on the log information.

The device matching unit 713 may set a device matching relationship based on a connection state of each device.

The device matching unit 713 may match a newly set social relationship to a newly discovered smart device, and set matching of a smart device not being used to be weak.

The agent management unit 714 may continuously manage a personalized service, the sociality of the user, and the device included in the sociality.

The agent protocol management unit 715 may evaluate a provided service by comparing social network information to user information of the cloud system.

The agent protocol management unit 715 may compare the social network information, for example, social relationship database of a content service providing a social network service and an address book of a smart device, to the user information of the cloud system.

The agent protocol management unit 715 may continuously evaluate and maintain a score of a service relationship and a social relationship.

The agent protocol management unit 715 may maintain a new social relationship of the user and a social relationship of a device to be in an optimal state.

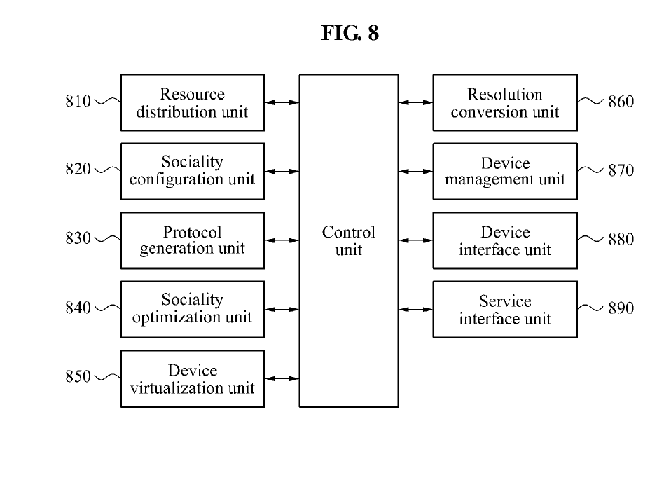

FIG. 8 is a diagram illustrating another example of a configuration of a cloud system according to an embodiment of the present invention.

Referring to FIG. 8, the cloud system includes a resource distribution unit 810 configured to monitor cloud service resources in real time and distribute the service resources, a sociality configuration unit 820 configured to recognize a device and configured sociality of a user and device sociality, a protocol generation unit 830 configured to configure a sociality service, a sociality optimization unit 840 configured to optimize the device sociality, a device virtualization unit 850 configured to continuously monitor a state of a service and manage connectivity between the sociality service and the device, a resolution conversion unit 860 configured to automatically output the state of the service based on a resolution module of the sociality device, a device management unit 870 configured to control the device, a device interface unit 880 configured to manage the device, and a service interface unit 890 configured to provide the sociality service.

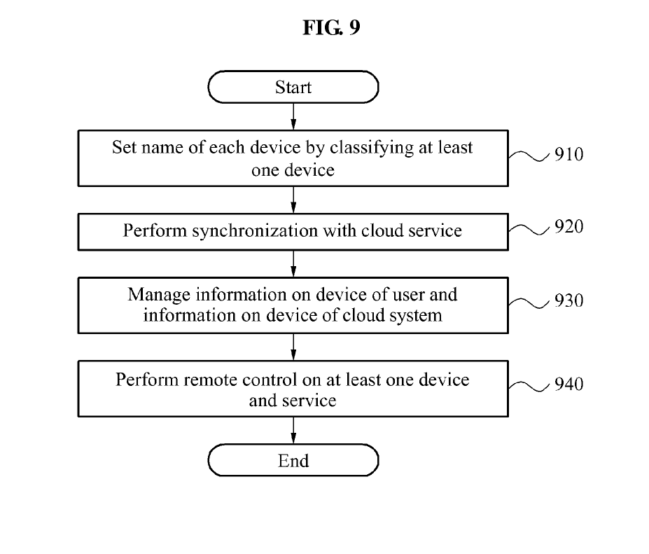

FIG. 9 is a flowchart illustrating an example of a method of configuring device sociality in a service area according to an embodiment of the present invention.

Referring to FIG. 9, in operation 910, the service area sets a name of each device by classifying at least one device.

In operation 920, the service area performs synchronization with a cloud service when device sociality for the at least one device is configured.

In operation 930, the service area manages information on a device of a user and information on a device of a cloud system.

In operation 940, the service area performs remote control on the at least one device and a service.

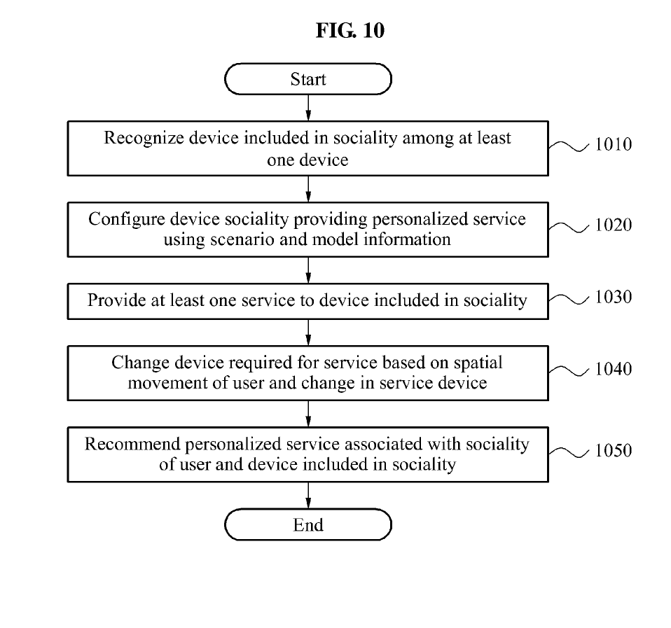

FIG. 10 is a flowchart illustrating an example of a method of configuring device sociality in a cloud system according to an embodiment of the present invention.

Referring to FIG. 10, in operation 1010, the cloud system recognizes a device to be included in sociality among at least one device.

In operation 1020, the cloud system configures device sociality that may provide a personalized service using a scenario and model information.

In operation 1030, the cloud system provides at least one service to the device included in the sociality.

In operation 1040, the cloud system changes a device required for the service based on a spatial movement of a user and a change in a service device.

In operation 1050, the cloud system recommends the personalized service associated with sociality of the user and the device included in the sociality.

For a detailed description of the method of configuring the device sociality through the cloud system, reference may be made to the descriptions provided in the foregoing.

According to an embodiment of the present invention, a device sociality configuring system may configure various service environments and integrate the service environments based on a personal service device of an individual.

The device sociality configuring system may analyze a relationship among smart devices, and provide an integral service environment in a cloud computing environment based on a procedure of smart device sociality that may connect smart devices required for a service.

The device sociality configuring system may integrate devices connected to a user through a social network and smart devices in a personalized service space such as information on an address book and a home network, and control service contents.

The device sociality configuring system may configure a real-time service environment required for the user and allow the user to receive a space control service.

The device sociality configuring system may enable use of identical services at anytime and anywhere by downloading an application service from a device applying an embedded function connected to a network in addition to a smartphone terminal.

The device sociality configuring system may be used for service development to process a service to be implemented in cloud computing fast, at anytime, and anywhere using mobility, immediacy, and spatiality of the user.

The device sociality configuring system may be used for development of an information processing service, construction of a smart business environment of a corporation, a multimedia service environment, a home management service, and a personalized service industrial field, which use a smart network, a wired and wireless network, and the like.

The above-described example embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments of the present invention, or vice versa.

Although a few example embodiments of the present invention have been shown and described, the present invention is not limited to the described example embodiments. Instead, it would be appreciated by those skilled in the art that changes may be made to these example embodiments without departing from the principles and spirit of the invention, the scope of which is defined by the claims and their equivalents.

1. A system for configuring device sociality, comprising:
a service area configured to construct at least one network through wired and wireless Internet; and
a cloud system configured to configure device sociality for at least one device in the service area.

2. The system of claim 1, wherein the service area comprises:
a naming unit configured to set a name of each device by classifying the at least one device;
a protocol recognition unit configured to perform synchronization with a cloud service when the device sociality is configured for the at least one device;
a service interface unit configured to manage information on a device of a user and information on a device of the cloud system; and
a service control unit configured to perform remote control on the at least one device and a service.

3. The system of claim 1, wherein the cloud system comprises:
a device recognition unit configured to recognize a device comprised in sociality among the at least one device;
a device sociality unit configured to configure device sociality providing a personalized service using a scenario and model information;
a device virtualization unit configured to provide at least one service to the device comprised in the sociality;
a service consecutive processing unit configured to change a device required for a service based on a spatial movement of a user and a change in a service device; and
a social analysis unit configured to recommend the personalized service associated with sociality of the user and the device comprised in the sociality.

4. The system of claim 3, wherein the device recognition unit comprises:
a user authentication unit configured to connect at least one user, the at least one provided service, and the device comprised in the sociality to allow a cloud service and a device sociality service to interwork;
a device recognition unit configured to verify a state of the device recognized through the cloud system;
a protocol generation unit configured to synchronize the recognized device and a device of the user with the at least one provided service; and
a device meta-extraction unit configured to recommend meta-information on a new device when the at least one provided service is suspended.

5. The system of claim 3, wherein the device sociality unit comprises:
a sociality configuration unit configured to configure connectivity of the recognized device to maintain a level of the at least one service and the device sociality;
a sociality optimization unit configured to manage a quality of service (QoS) based on a communication environment of the model information;
a device meta-management unit configured to generate an ontology structured data storage rule and manage device meta-information;
a ranking processing unit configured to determine a ranking of a device required for a service by evaluating the device meta-information, service information, and service environment information, and connect and reset the at least one device by referring to the ranking; and
a protocol generation unit configured to manage the resetting of the at least one device and service connectivity.

6. The system of claim 3, wherein the device virtualization unit comprises:
a virtualization management unit configured to manage cloud virtualization and device virtualization, and virtualize a resource corresponding to each device;
a resource distribution unit configured to distribute a resource and information of the cloud system required for the service to be provided;
a service resource conversion unit configured to unify service codes of a device receiving the service and the resource; and
a service configuration unit configured to configure device sociality in a virtualized form to be provided to the user using the unified service code and the configured device sociality.

7. The system of claim 3, wherein the service consecutive processing unit comprises:
a service log analysis unit configured to analyze a state of use of the provided service and a log of the service device;
a device recommendation unit configured to recommend a device adjacent to the user and without interworking with another service and being on standby;
a device interface unit configured to manage an event and a message directly controlling the service device; and
a service interface unit configured to allow the service to be provided to be selected or reconfigured.

8. The system of claim 3, wherein the social analysis unit comprises:
a log information collection unit configured to collect log information used for the service to be provided and log information associated with a state of the service to be provided;
a social setting unit configured to set a relationship between a situation of a user comprised in sociality and the device comprised in the sociality based on the collected log information;
a device matching unit configured to set a device matching relationship based on a connection state of each device;
an agent management unit configured to manage the personalized service, the sociality of the user, and the device comprised in the sociality; and
an agent protocol management unit configured to evaluate the service to be provided by comparing social network information to user information of the cloud system.

9. A system for configuring device sociality, comprising:
a device recognition unit configured to recognize a device comprised in sociality among at least one device comprised in at least one network;
a device sociality unit configured to store a scenario and model information to configure device sociality providing a personalized service;
a device virtualization unit configured to provide at least one service to the device comprised in the sociality;
a service consecutive processing unit configured to change a device required for a service based on a spatial movement of a user and a change in a service device; and
a social analysis unit configured to recommend the personalized service associated with sociality of the user and the device comprised in the sociality.

10. A system for configuring device sociality, comprising:
a resource distribution unit configured to monitor cloud service resources in real time and distribute the cloud service resources;
a sociality configuration unit configured to recognize a device and configure sociality of a user and device sociality;
a protocol generation unit configured to configure a sociality service;
a sociality optimization unit configured to optimize the device sociality;
a device virtualization unit configured to manage connection between the sociality service and the device by continuously monitoring a state of a service;
a resolution conversion unit configured to automatically output the state of the service based on a resolution module of the device;
a device management unit configured to control the device;
a device interface unit configured to manage the device; and
a service interface unit configured to provide the sociality service.

11. A method of configuring device sociality, comprising:
constructing at least one network through wired and wireless Internet; and
configuring device sociality for at least one device comprised in the at least one network.

12. The method of claim 11, further comprising:
setting a name of each device by classifying the at least one device;
performing synchronization with a cloud service when the device sociality is configured for the at least one device;
managing information on a device of a user and information on a device of a cloud system; and
performing remote control on the at least one device and a service.

13. The method of claim 11, further comprising:
recognizing a device comprised in sociality among the at least one device;
configuring device sociality providing a personalized service using a scenario and model information;
providing at least one service to the device comprised in the sociality;
changing a device required for a service based on a spatial movement of a user and a change in a service device;
recommending the personalized service associated with sociality of the user and the device comprised in the sociality.

14. The method of claim 13, wherein the recognizing of the device comprises:
connecting at least one user, the at least one service to be provided, and the device comprised in the sociality to allow a cloud service and a device sociality service to interwork with each other;
verifying a state of the device recognized through a cloud system;
synchronizing the recognized device and a device of the user with the at least one service to be provided; and
recommending meta-information on a new device when the at least one service to be provided is suspended.

15. The method of claim 13, wherein the configuring of the device sociality comprises:
configuring connectivity of the recognized device to maintain a level of the at least one service and the device sociality;
managing a quality of service (QoS) based on a communication environment of the model information;
generating an ontology structured data storage rule and managing device meta-information;
determining a ranking of a device required for a service by evaluating the device meta-information, service information, and service environment information;
connecting and resetting the at least one device by referring to the ranking; and
managing the resetting of the at least one device and service connectivity.

16. The method of claim 13, wherein the providing of the at least one service comprises:
managing cloud virtualization and device virtualization, and virtualizing a resource corresponding to each device;
distributing a resource and information of a cloud system required for the service to be provided;
unifying service codes of a device receiving the service to be provided and the resource; and
configuring device sociality in a virtualized form to be provided to the user using the unified service code and the configured device sociality.

17. The method of claim 13, wherein the changing of the device comprises:
analyzing a state of use of the provided service and a log of the service device;
recommend a device adjacent to the user and without interworking with another service and being on standby;
managing an event and a message directly controlling the service device; and
controlling to allow the service to be provided to be selected or re-configured.

18. The method of claim 13, wherein the recommending of the personalized service comprises:
collecting log information used for the service to be provided and information associated with a state of the service to be provided;
setting a relationship between a situation of a user comprised in sociality is configured and the device comprised in the sociality based on the collected log information;
setting a device matching relationship based on a connection state of each device;
managing the personalized service, the sociality of the user, and the device comprised in the sociality; and
evaluating the service to be provided by comparing social network information to user information of the cloud system.

19. A non-transitory computer-readable storage medium comprising a program comprising instructions to cause a computer to perform the method of claim 11.
